(19) United States
(12) Patent Application Publication
(10) Pub. No.: US 2026/0124106 A1
(43) Pub. Date: May 7, 2026

(54) SPIRAL PULL AND INSERT STRUCTURE OF MASSAGE HEAD

(71) Applicant: Zhejiang Red And Black Technology Co.,Ltd, Lishui (CN)

(72) Inventors: Xinyi Shu, Jinyun County (CN); Lifeng Shu, Jinyun County (CN)

(21) Appl. No.: 18/961,301

(22) Filed: Nov. 26, 2024

(30) Foreign Application Priority Data
Nov. 4, 2024 (CN) 2024226797160

(51) Int. Cl. A61H 23/00

(52) U.S. Cl. CPC A61H 23/006; A61H 2201/1664; A61H 2201/1685

(57) ABSTRACT

A spiral pull and insert structure of a massage head includes a massage head, a massage head cover, a plastic press member, and a sliding rod holder. The massage head cover is sleeved to the massage head. The massage head includes a rotating and inserting member. A rotating and inserting slide matching the rotating and inserting member is provided in the plastic press member, and an outer layer of the plastic press member is nested in and locked with the sliding rod holder. When the rotating and inserting member slides to a bottom of the rotating and inserting slide, the plastic press member is sleeved on the massage head cover. The spiral pull and insert structure of a massage head effectively resolves problems of screw stripped and jams in conventional designs using an innovative rotating and inserting method. In addition, processing is simplified, and processing costs are reduced.

### TECHNICAL FIELD

The present disclosure relates to a field of percussion massagers, and in particular to a spiral pull and insert structure of a massage head.

### BACKGROUND

In the field of massagers, as a component that is directly in contact with the human body and applies a massage force, the structural design and the connection mode of a massage head are critical for the overall performance of products and user experience of users.

Conventional massage heads are mostly connected in a threaded manner, which meets basic connection needs to a certain extent. However, there is a phenomenon of screws stripped during actual applications, resulting in jams. In addition, if the massage head is directly connected to a sliding rod holder, a thread needs to be processed on the sliding rod holder. Therefore, processing costs are high.

### SUMMARY

In view of this, it is necessary to provide a spiral pull and insert structure of a massage head to resolve the above problem. The spiral pull and insert structure of a massage head includes a massage head, a massage head cover, a plastic press member, and a sliding rod holder, where the massage head cover is sleeved to the massage head, the massage head includes a rotating and inserting member, a rotating and inserting slide matching the rotating and inserting member is provided in the plastic press member, an outer layer of the plastic press member is nested in and locked with the sliding rod holder, and when the rotating and inserting member slides to a bottom of the rotating and inserting slide, the plastic press member is sleeved on the massage head cover.

Preferably, the rotating and inserting slide includes a rotating channel and an inserting channel, the rotating channel is connected to the inserting channel, and a protrusion is disposed at an edge of a bottom of the rotating channel.

Preferably, the massage head cover includes an abutting portion, a limiting portion, and an adapting portion, when the massage head cover is sleeved on the massage head, the abutting portion abuts against the massage head, when the plastic press member is disposed on the massage head cover, the limiting portion is clamped with the edge of the bottom of the rotating channel, and the adapting portion is adapted to a front section of the plastic press member.

Preferably, a limiting edge is disposed along an inner wall of the sliding rod holder and used to limit the plastic press member.

Preferably, a boss is uniformly disposed on an outer side of the plastic press member along a direction of the rotating and inserting slide.

Preferably, the plastic press member and the sliding rod holder each are locked in a threaded manner.

### BRIEF DESCRIPTION OF THE DRAWINGS

FIG. 1 is a schematic diagram of a structure of a spiral pull and insert structure of a massage head according to an embodiment of the present disclosure;

FIG. 2 is an exploded view of a spiral pull and insert structure of a massage head according to an embodiment of the present disclosure;

FIG. 3 is a profile of a spiral pull and insert structure of a massage head according to an embodiment of the present disclosure;

FIG. 4 is a schematic diagram of a structure of a massage head cover according to an embodiment of the present disclosure;

FIG. 5 is a schematic diagram of a structure of a plastic press member according to an embodiment of the present disclosure; and

FIG. 6 is a schematic diagram of a structure of a sliding rod holder according to an embodiment of the present disclosure.

Reference numerals: 1: massage head; 11: rotating and inserting member; 2: massage head cover; 21: abutting portion; 22: limiting portion; 23: adapting portion; 3: plastic press member; 31: rotating and inserting slide; 311: rotating channel; 312: inserting channel; 313: protrusion; 32: boss; 4: sliding rod holder; 41: limiting edge.

### DETAILED DESCRIPTION OF THE EMBODIMENTS

To make the objectives, technical solutions and the advantages of the utility model clearer, a spiral pull and insert structure of a massage head provided in the present disclosure is described in further detail below with reference to the drawings and embodiments. Understandably, the described embodiments are merely intended to explain the present disclosure, rather than to limit the present disclosure.

It should be understood that in the description of the present disclosure, unless otherwise specified, “a plurality of” means two or more; and terms such as “central”, “longitudinal”, “transverse”, “upper”, “lower”, “left”, “right”, “inside”, “outside”, “front”, “rear”, “head”, “tail”, “vertical”, “horizontal”, “top”, and “bottom” indicate the orientation or position relationships based on the drawings. They are merely intended to facilitate and simplify the description of the present disclosure, rather than to indicate or imply that the mentioned device or components must have a specific orientation or must be constructed and operated in a specific orientation. Therefore, these terms should not be construed as a limitation to the present disclosure. Moreover, the terms “first”, “second”, and “third” are merely used for description, and are not intended to indicate or imply relative importance.

In the description of the present disclosure, it should be noted that, unless otherwise clearly specified, meanings of terms “install”, “connected with”, and “connected to” should be understood in a board sense. For example, the connection may be a fixed connection, a removable connection, or an integral connection; may be a mechanical connection or an electrical connection; may be a direct connection or an indirect connection by using an intermediate medium; or may be intercommunication between two components. Those of ordinary skill in the art may understand specific meanings of the above terms in the present disclosure based on a specific situation.

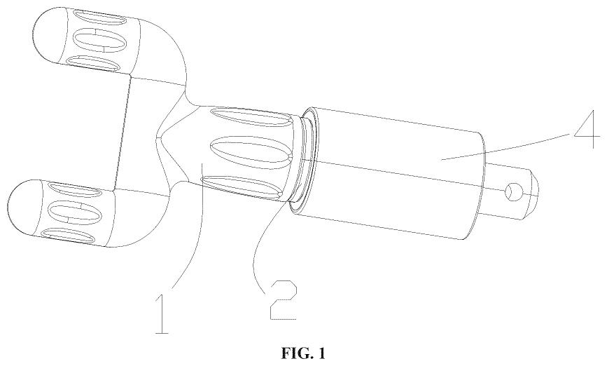

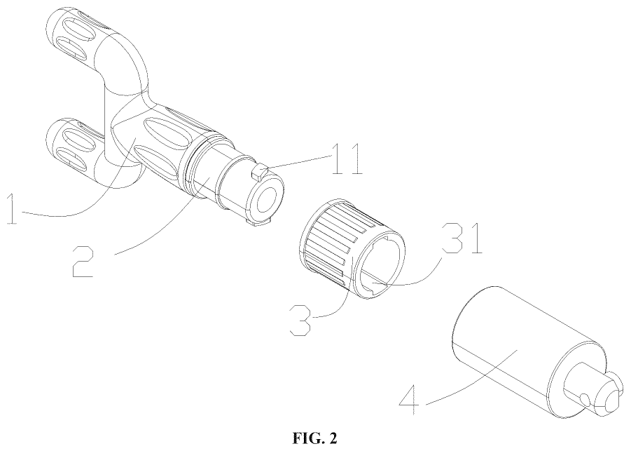

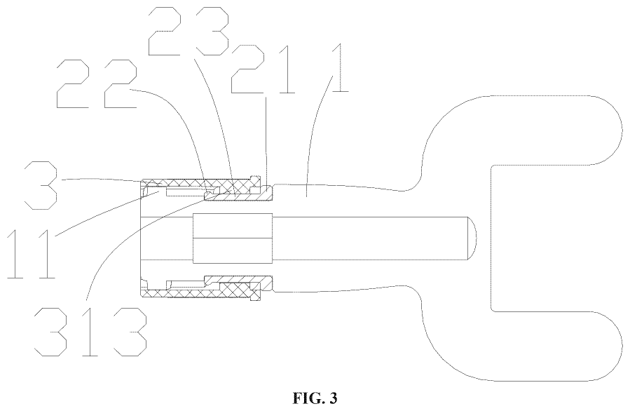

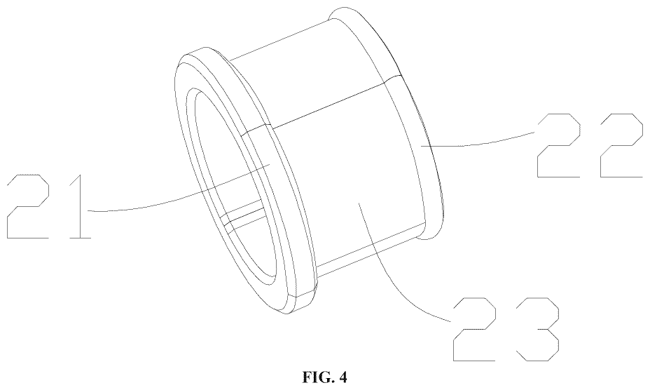

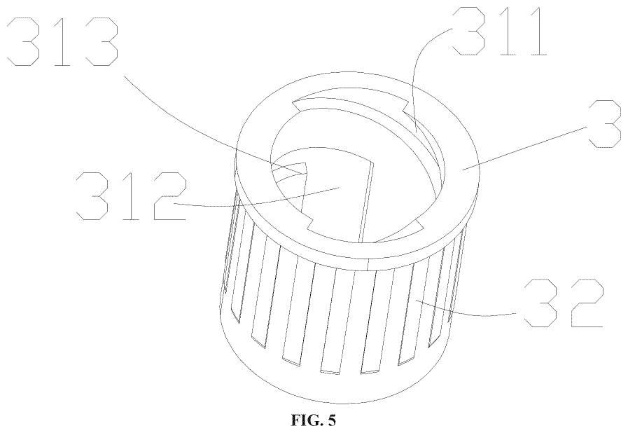

Referring to FIG. 1 to FIG. 6, a spiral pull and insert structure of a massage head provided in the embodiments of the present disclosure includes a massage head 1, a massage head cover 2, a plastic press member 3, and a sliding rod holder 4. The massage head cover 2 is sleeved to the massage head 1. The massage head 1 includes a rotating and inserting member 11. A rotating and inserting slide 31 matching the rotating and inserting member 11 is provided in the plastic press member 3, and an outer layer of the plastic press member 3 is nested in and locked with the sliding rod holder 4. When the rotating and inserting member 11 slides to a bottom of the rotating and inserting slide 31, the plastic press member 3 is sleeved on the massage head cover 2.

In this embodiment, the spiral pull and insert structure of a massage head 1 is designed to optimize the mounting and removing processes of the massage head 1 of a percussion massager, to reduce phenomena of screw stripped and jams. In addition, the processing difficulty of the spiral pull and insert structure of a massage head is simplified. The spiral pull and insert structure of a massage head mainly includes four parts, namely, the massage head 1, the massage head cover 2, the plastic press member 3, and the sliding rod holder 4. The rotating and inserting member 11 is designed on the outer side of the massage head 1, has an accurate shape and size, and is used for implementing a stable rotary connection. The massage head cover 2 is tightly fitted with the massage head 1, playing the role of fixation and protection.

The rotating and inserting slide 31 matching the rotating and inserting member 11 of the massage head 1 is disposed inside the plastic press member 3 which is a key connection component. This design allows the massage head 1 to smoothly enter or exit along the rotating and inserting slide 31 in a rotation manner, to effectively resolve the problem of screws stripped during conventional threaded connections. The plastic press member 3 is made of a lightweight material, and has good abrasion resistance and processability. Therefore, processing difficulty and processing costs are reduced.

The outer layer of the plastic press member 3 is disposed on the sliding rod holder 4, and firmly connected to the sliding rod holder 4 using a locking mechanism, to ensure stability and durability of the spiral pull and insert structure of a massage head. The sliding rod holder 4 adopts a design of a non-direct connection to the massage head 1, and the plastic press member 3 is used as a mediation member. This avoids complex processing needs for the interior of the metal sliding rod holder 4, and improves flexibility and reliability of connection portions.

In conclusion, the spiral pull and insert structure of a massage head 1 effectively resolves problems of screw stripped and jams in conventional designs using an innovative rotating and inserting method. In addition, processing is simplified, and processing costs are reduced. The massage head 1 is connected to the sliding rod holder 4 via the plastic press member 3 which is used as the mediation member. This ensures solidity of connections, and improves user experience.

Referring to FIG. 1 to FIG. 6, in another embodiment, the rotating and inserting slide 31 includes a rotating channel 311 and an inserting channel 312. The rotating channel 311 is connected to the inserting channel 312, and a protrusion 313 is disposed at an edge of a bottom of the rotating channel 311.

In this embodiment, the rotating and inserting slide 31 includes two portions, namely, the rotating channel 311 and the inserting channel 312. The rotating channel 311 and the inserting channel 312 are interconnected, to form an integrated slide structure. The rotating channel 311 is designed to guide the rotating and inserting member 11 of the massage head 1 to rotate, and a shape of an inner wall of the rotating channel 311 matches a shape of the rotating and inserting member 11, to ensure smooth rotation. The protrusion 313 is disposed at the edge of the bottom of the rotating channel 311. When the rotating and inserting member 11 is rotated to a specific position, the protrusion 313, as a limiting structure or a guide structure, is in contact with the rotating and inserting member 11 and guides the rotating and inserting member 11 to smoothly enter the inserting channel 312.

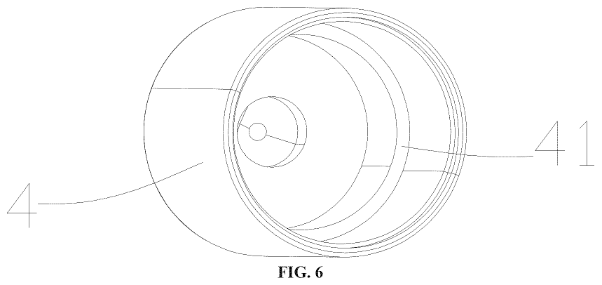

Referring to FIG. 1 and FIG. 6, in another embodiment, the massage head cover 2 includes an abutting portion 21, a limiting portion 22, and an adapting portion 23. When the massage head cover 2 is sleeved on the massage head 1, the abutting portion 21 abuts against the massage head 1. When the plastic press member 3 is disposed on the massage head cover 2, the limiting portion 22 is clamped with the edge of the bottom of the rotating channel 311, and the adapting portion 23 is adapted to a front section of the plastic press member 3.

In this embodiment, when the massage head cover 2 is sleeved on the massage head 1, the abutting portion 21 is tightly fitted with an outer surface of the massage head 1, to form a stable abutting connection. This ensures that the massage head 1 does not loosen or fall off during working, and enhances solidity of the connection.

Because the adapting portion 23 is used as a transition part between the massage head cover 2 and the plastic press member 3, the shape and size of the adapting portion 23 are tightly adapted to the front section of the plastic press member 3, to ensure that the massage head cover 2 is smoothly docked with the plastic press member 3, thereby reducing friction and resistance.

As the plastic press member 3 is further sleeved on the massage head cover 2, the limiting portion 22 is screwed into the bottom of the rotating channel 311. When the plastic press member 3 rotates and slides down to a specific position, the limiting portion 22 is clamped with the protrusion 313 at the edge of the bottom of the rotating channel 311, to implement a solid connection between the limiting portion 22 and the rotating channel 311. This clamping design effectively prevents the plastic press member 3 from accidentally falling off during use, and improves reliability of the spiral pull and insert structure of a massage head.

In conclusion, the abutting portion 21 abuts against the massage head 1, the adapting portion 23 is partially fitted with the front portion of the plastic press member 3, and the limiting portion 22 clamps the protrusion 313, to form a solid connection between the massage head 1 and the plastic press member 3.

Referring to FIG. 1 to FIG. 6, in another embodiment, a limiting edge 41 is disposed along an inner wall of the sliding rod holder 4 and used to limit the plastic press member 3.

In this embodiment, the limiting edge 41 is disposed along the inner wall of the sliding rod holder 4. The limiting edge 41 is tightly attached to the inner wall of the sliding rod holder 4, to form an annular limiting structure. The limiting edge 41 is designed to accurately limit and fix the plastic press member 3, to prevent the plastic press member 3 from shifting relative to the sliding rod holder 4 during working.

Referring to FIG. 1 and FIG. 6, in another embodiment, a boss 32 is uniformly disposed on an outer side of the plastic press member 3 along a direction of the rotating and inserting slide 31.

In this embodiment, a plurality of bosses 32 are regularly disposed on the outer side of the plastic press member 3 in an extension direction of the rotating and inserting slide 31. A main function of the boss 32 is as follows: When the massage head 1 moves in a reciprocating movement direction (which is the same as the direction of the rotating and inserting slide 31) of the massage head 1, friction between the plastic press member 3 and the sliding rod holder 4 is significantly increased by increasing contact areas of the plastic press member 3 and the sliding rod holder 4 in the direction. This design ensures that when the massage head 1 moves forward and backward, the plastic press member 3 may be firmly maintained in the sliding rod holder 4. Therefore, sliding or loosening caused by vibration or an impact force can be effectively prevented, and stability and reliability of the work of the massage head 1 can be ensured.

Referring to FIG. 1 to FIG. 6, in another embodiment, the plastic press member 3 and the sliding rod holder 4 each are locked in a threaded manner.

In this embodiment, because a threaded structure matching the internal threads of the sliding rod holder 4 is disposed on the outer wall of the plastic press ember 3, when the plastic press member 3 is rotated and pushed into the sliding rod holder 4, the threads of the plastic press member 3 and the sliding rod holder 4 are tightly engaged with each other, to form a firm locking state.

The above embodiments are only preferred ones of the present disclosure, and are not intended to limit the present disclosure in any form. Although the present disclosure has been disclosed by the foregoing embodiments, these embodiments are not intended to limit the present disclosure. Any person skilled in the art may make some changes or modifications to implement equivalent embodiments with equivalent changes by using the technical contents disclosed above without departing from the scope of the technical solution of the present disclosure. Any simple modification, equivalent change and modification made to the foregoing embodiments according to the technical essence of the present disclosure without departing from the content of the technical solution of the present disclosure shall fall within the scope of the technical solution of the present disclosure.

What is claimed is:

1. A spiral pull and insert structure of a massage head, comprising a massage head, a massage head cover, a plastic press member, and a sliding rod holder, wherein the massage head cover is sleeved to the massage head, the massage head comprises a rotating and inserting member, a rotating and inserting slide matching the rotating and inserting member is provided in the plastic press member, an outer layer of the plastic press member is nested in and locked with the sliding rod holder, and when the rotating and inserting member slides to a bottom of the rotating and inserting slide, the plastic press member is sleeved on the massage head cover.

2. The spiral pull and insert structure of a massage head according to claim 1, wherein the rotating and inserting slide comprises a rotating channel and an inserting channel, the rotating channel is connected to the inserting channel, and a protrusion is disposed at an edge of a bottom of the rotating channel.

3. The spiral pull and insert structure of a massage head according to claim 2, wherein the massage head cover comprises an abutting portion, a limiting portion, and an adapting portion, when the massage head cover is sleeved on the massage head, the abutting portion abuts against the massage head, when the plastic press member is disposed on the massage head cover, the limiting portion is clamped with the edge of the bottom of the rotating channel, and the adapting portion is adapted to a front section of the plastic press member.

4. The spiral pull and insert structure of a massage head according to claim 1, wherein a limiting edge is disposed along an inner wall of the sliding rod holder and used to limit the plastic press member.

5. The spiral pull and insert structure of a massage head according to claim 1, wherein a boss is uniformly disposed on an outer side of the plastic press member along a direction of the rotating and inserting slide.

6. The spiral pull and insert structure of a massage head according to claim 1, wherein the plastic press member and the sliding rod holder each are locked in a threaded manner.
